(19) United States
(12) Patent Application Publication
(10) Pub. No.: US 2025/0026363 A1
(43) Pub. Date: Jan. 23, 2025

(54) SITUATIONAL AWARENESS SYSTEM FOR A VEHICLE PROVIDING A PARAMETERIZED FIELD OF VIEW

(71) Applicants: David Eugene Harp, Brooklyn, NY (US); Brandon Emerson, Council, ID (US)

(72) Inventors: David Eugene Harp, Brooklyn, NY (US); Brandon Emerson, Council, ID (US)

(21) Appl. No.: 18/779,872

(22) Filed: Jul. 22, 2024

Related U.S. Application Data
(60) Provisional application No. 63/514,808, filed on Jul. 21, 2023.

(51) Int. Cl. B60W 50/14; B60K 35/28; G06V 20/58

(52) U.S. Cl. CPC B60W 50/14; B60K 35/28; G06V 20/58; B60K 2360/176; B60K 2360/178; B60K 2360/188; B60W 2050/146; B60W 2420/403

(57) ABSTRACT

An onboard camera, motion detection, and early warning system for monitoring a parameterized safety zone around personal transportation systems for detecting motion, tracking changes, and monitoring the parameterized safety zone for providing early warning notifications.

### CROSS-REFERENCE TO RELATED APPLICATION

This application claims the benefit of priority of U.S. provisional application No. 63/514,808, filed 21 Jul. 2023, the contents of which are herein incorporated by reference.

### BACKGROUND OF THE INVENTION

The present disclosure relates vehicle situational awareness systems and, more particularly, an onboard camera, motion detection sensors, and an early warning system for monitoring a parameterized safety zone around personal transportation systems for detecting motion, tracking changes, and monitoring the parameterized safety zone to provide early warning notifications.

Hands-free, verbally commanded operation of at least partially self-driving vehicles is gaining acceptance. Safety, however, is still a concern for those who have yet to adopt the technology and as a result is suppressing demand for such vehicles. Self-driving vehicles use cameras and motion sensors to prevent accidents and collisions, but blind spots persist with current camera and motion sensor systems for self-driving vehicles.

As can be seen, there is a need for a system for monitoring regions and zones adjacent to personal transportation vehicles for providing early warning notifications.

### SUMMARY OF THE INVENTION

The system embodied by the present invention includes a plurality of motion sensors and a rearward-facing camera equipped to a vehicle to monitor a 360-degree motion-sensed region and a 120-plus degrees parameterized rearward field of view of the vehicle, both visible on a display for the driver of two-wheeled vehicles, e.g., motorcycles, and three-wheeled and four-wheeled work and recreation vehicles, e.g. all-terrain and utility vehicles, and the like.

In one aspect of the present invention, a situational awareness system for a vehicle provides a rearward-facing camera disposed on a vehicle equipped with the situational awareness system, the rearward-facing camera having a rearward field of view capturing image data; an image processor operatively associated with the rearward-facing camera, wherein the image processor is operable to process image data captured by the rearward-facing camera to at least detect objects present in the rearward field of view of the rearward-facing camera; a command pad having a display, the display operable to display images for viewing by a driver of the equipped vehicle; and the display is operable to display video images representative of video images captured by said rearward-facing camera in a parameterized field of view representation for viewing by the driver of the equipped vehicle, wherein the parameterized field of view representation comprises a safe zone, an alert zone, a hazard zone, and a collision zone, and wherein each zone is associated with a radial distance from the rearward-facing camera.

In another aspect of the present invention, the situational awareness system further provides the following: wherein each zone of the parameterized field of view is represented in a contrasting color; wherein the radial distances for the safe zone, the alert zone, the hazard zone, and the collision zone are between zero to fifteen feet, between fifteen and twenty-five feet, between twenty-five and thirty feet, and between thirty and sixty feet, respectively; a left blinker and a right blinker, both blinkers physically connected to a housing of the rearward-facing camera and electrically connected to the command pad; wherein the display is operable to display images representative of an activation state of the left blinker and the right blinker; further providing an accessory attachment having a stem portion that extends between a coupler portion and a branch portion, wherein the branch portion is joined to a crossmember, wherein at each end of the crossmember is the left and right blinkers, respectively, wherein the coupler portion removably connects directly to a housing of the rearward-facing camera.

These and other features, aspects and advantages of the present invention will become better understood with reference to the following drawings, description and claims.

### BRIEF DESCRIPTION OF THE DRAWINGS

FIG. 1 is a top plan view of a vehicle situational awareness system, according to an example embodiment.

FIG. 2 is a schematic view of a display 19 of a command pad 18, as viewable by the driver of the vehicle. The command pad 18 provides a plurality of safety representations on the display 19.

FIG. 3 is a rear exploded elevation view of a rear accessory attachment 12A of the invention, according to an example embodiment.

FIG. 4 is a detailed diagrammatical view of a parameterized field of view 16C generated, which is one of plurality of the safety representations on the display 19.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

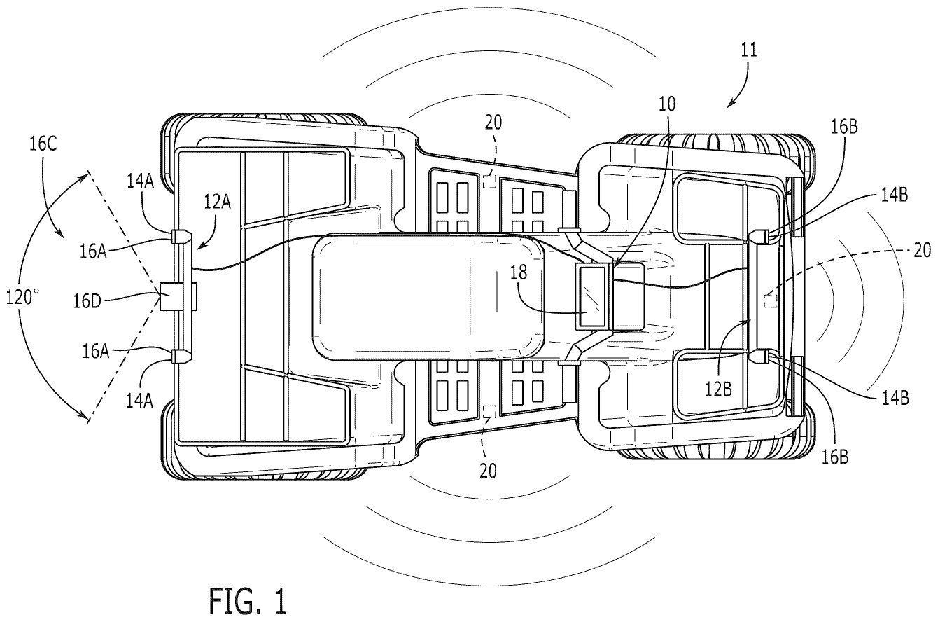

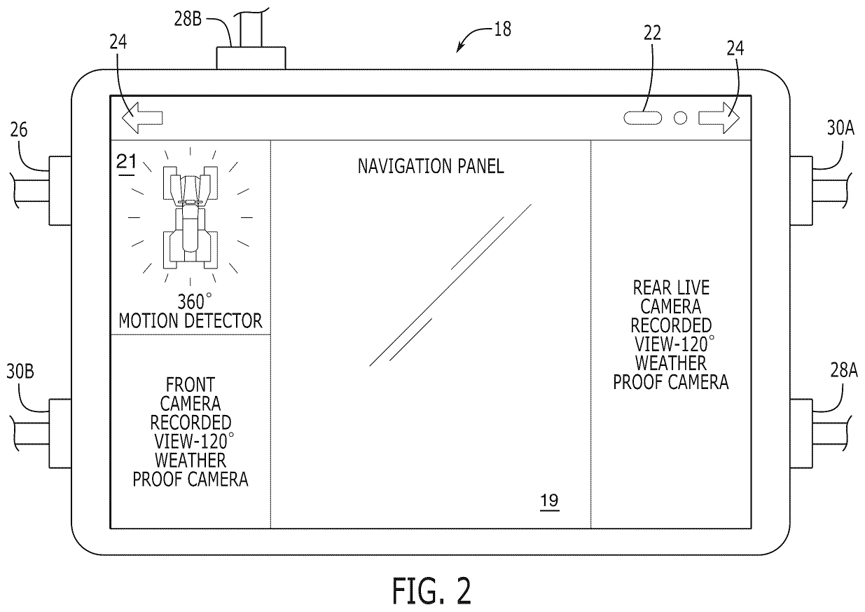

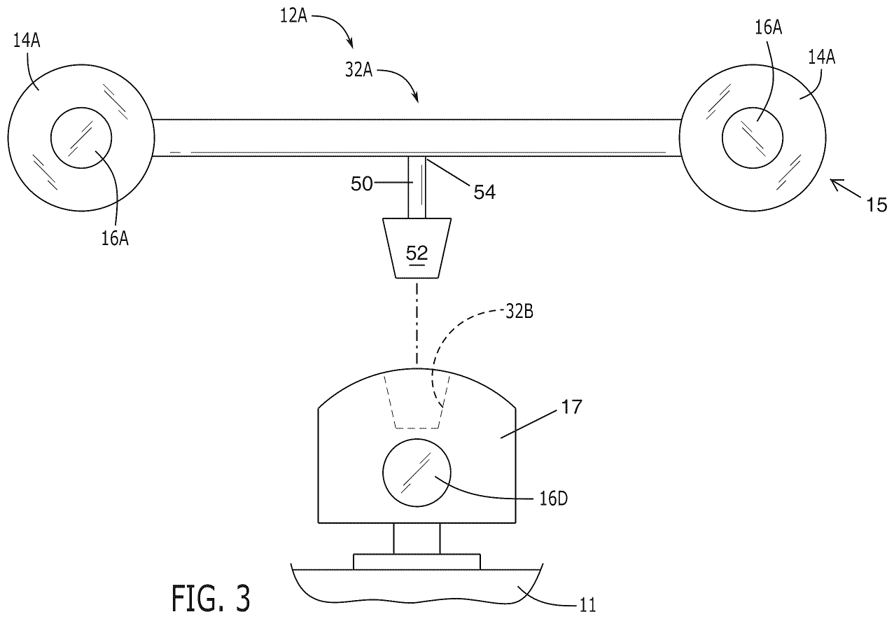

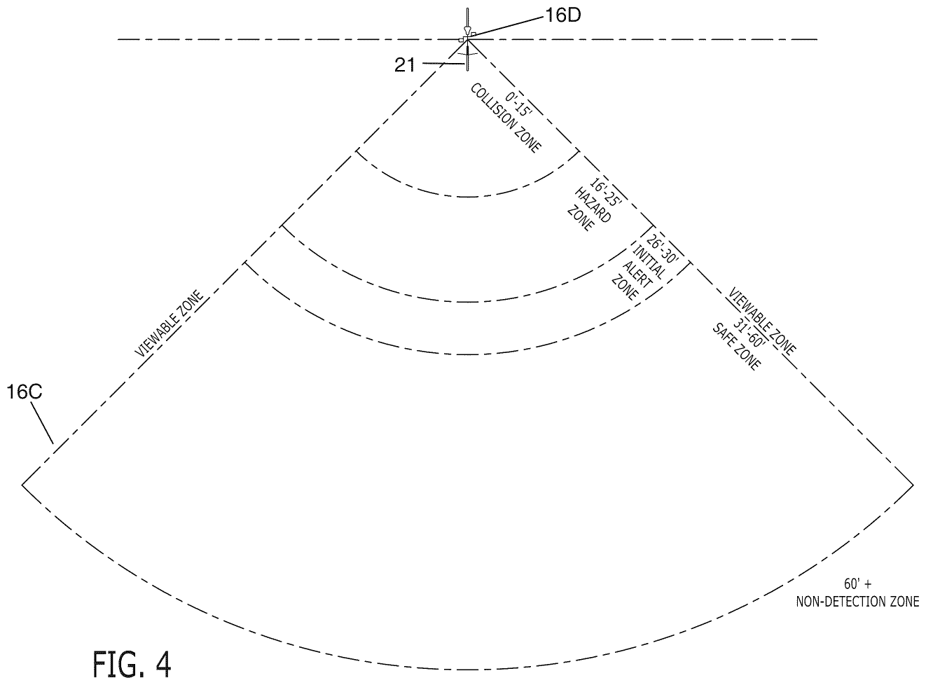

Referring to FIGS. 1 through 3, the present invention includes a vehicular situational awareness system 10 having a forward-facing camera and a rearward-facing camera 16D having a rearward field of view 16C. The output of rearward-facing camera 16D is electrically coupled to an image processor by way of a decoding device. The image processor is operable to process image data captured by the rearward-facing camera 16D to at least detect objects in the rearward field of view 16C. The image processor output is electrically coupled to an encoding device whereby the output of the encoding device coupled to a display 19 of a command pad 18 to be viewable by a driver of the vehicle 11. The display 19 of command pad 18 may provide a representation of the detected objects in a parameterized field of view representation 40, as illustrated in FIG. 4 and disclosed in more detail below.

The display 19 may also provide representations of a 360-degree field adjacent the vehicle 11, wherein motion sensed through one or more motion sensors 20 equipped on the vehicle 11 may also be represent on the 360-degree field. The display 19 may also provide an operable display of a power button 22 and blinker controls 24. The command pad 18 provides a motion sensor port 26 for the output of encoding devices operative associated with the motion sensors 20 as well as ports 28A, 28B, 30A, and 30B electrically coupled to the output of a right blinker, a left blinker, the rearward-facing camera 16D, and the forward-facing camera, respectively.

The vehicle 11 provides a rear accessory attachment 12A and a front accessory attachment 12B. Each accessory attachment may have a stem portion 50 that extends between a coupler portion 52 and a branch portion 54. The branch portion 54 is joined along a crossmember 32A. At each end of the crossmember 32A is a blinker and lamp element 15. The blinker and lamp element 15 of the rear accessory attachment 12A has a rear blinker 14A and a rear lamp 16A. Likewise, the front accessory attachment 12B provides the front blinker 14B and the front lamps 16B.

The coupler portion 52 removably engages an accessory attachment port 32B of a housing 17 of the frontward-facing or rearward-facing camera 16D. The accessory attachment port 32B may be fructo-conical recess dimensioned and shaped to receive the fructo-conical coupler portion 52.

The cameras 16D, the motion sensors 20, other vehicle situational awareness system components, and the command pad 18 embodied in the present invention are configured to synchronize to a user's mobile computing device (e.g., smart phone), thereby enabling navigation applications and other smart phone functionality to be represented along the display 19 of the command pad 18, thereby providing a 360-degree motion blind spot indicator representation 21 in the form of the 360-degree field adjacent the vehicle 11.

The rearward-facing camera 16D may be designated as the camera with motion sensors/detection technology for blind spot warning and alerts. The forward-facing camera may not have the blind spot technology. Each camera will have a 120-plus-degree field of view.

Referring to FIG. 4, the vehicle situational awareness system 10 embodies a motion detection technology and early warning system providing motion detection/sensors technology having artificial intelligence (AI) technology, microwave, or any other past, present, or future technologies that are available or will be available. The detection technology may be built into the camera 16D to enable a 120 plus degree field of view 16C that will detect objects (e.g., people and/or vehicles) that are behind or to the left or right of the rearward-facing camera 16D.

The field of view 16C may be parameterized, represented in terms of, as a function of, and/or based on the radial distance from any point within the parameterized field of view 16C to the rearward-facing camera 16D. Accordingly, the parameterized field of view 16C may be represented as a plurality of zones:
i. Non-detection zone—61+ feet radial distance from the rearward-facing camera 16D;
ii. Safe zone—31-60 feet radial distance from the rearward-facing camera 16D;
iii. Alert zone—26-30 feet radial distance from the rearward-facing camera 16D;
iv. Hazard zone—16-25 feet radial distance from the rearward-facing camera 16D; and
v. Collision zone—0-15 feet radial distance from the rearward-facing camera 16D.

The vehicle situational awareness system 10 is configured so that if an object (e.g., a person or vehicle) is in the alert zone of the parameterized field of view 16C then the display 19 will notify the rider and can also make an audible notification as well. The alerts zones will be to the left and right of the riders and directly behind the vehicle 11. In some embodiments, the alert zone is further parameterized as a function of an offset in degrees or radians relative to a radial extending along a longitudinal axis 21 shared by the body of vehicle 11. For instance, a direct zone (of the alert zone) is defined as directly behind the rearward-facing camera 16D—i.e., from zero to a 15-degree offset (either side thereof) from the longitudinal axis 21. The alert zone may be further parameterized in a left and right zones associated with coordinates outside of the direct zone. The right and left zones may be for the detection and notification of objects to the side (e.g., in an adjacent lane) of the vehicle 11. The zones to the left and the right will be the notification zones sensed by the motion sensors 20, activated to alert the rider on the display 19 and/or via an audible notification.

The side distances from the rear camera out to the left and right may be between zero feet to twelve feet. The direct zone may be visually represented on the display 19 of the command pad 18, where the rider will be able to visually see what is behind them and what can be seen in the 120-degrees plus parameterized field of view 16C.

An apparatus or accessory attachment may include lamps 16 and blinkers 14, giving vehicles extra visibility by having lights and notifications of intent when turning left or right.

The display 19 of the command pad 18 may be a four-inch to seven-inch control panel monitor (CPM) surrounded by a border less than half an inch. The CPM may include a touchscreen and with only a power button and all other buttons would be on the screen.

The accessory attachment 12A may be made of aluminum or other more robust metal and include quick release mounting bracket and locking mechanism associated with the accessory attachment 12A.

The command pad 18 may be made of water resistant, dust proof (e.g., IP67), and shock resistant material that wicks away moisture, and have a covering for each port 26 through 30B. The command pad 18 may have a memory card—e.g., mini/micro-SD or like card for recording and easy removal for uploading video content. The command pad 18 may provide speakers enabling audible notification on the CPM. The command pad 18 may provide a backup video connection port and charging port on the back of the CPM, a charging cable port, and the like. The command pad 18 may provide a power source/battery with over five hours of power for the vehicle situational awareness system 10.

The cameras 16D may be approximately one inch square and adjustable up to 170-degrees relative to the longitudinal axis 21 via hard wired, removable (quick and easy release) connections. The camera 16D may provide night vision, bright light reduction, vibration reduction capabilities. The camera 16D may have a housing 17 that is made from robust water and dust proof components (e.g., IP67).

Wireless communication (e.g., Bluetooth™) may be provided to enable users to bring their own devices like their phone and will connect via a mobile software application.

Other features include the following: locking feature to mounting system to prevent theft and sufficient cabling to enable hard wired as well as removable connections to mounting bracket, the CPM, or the cameras.

Software and firmware aspects may include navigation applications, recording options available with removable flash cards (e.g. microSD, etc.), blind spot notifications (audible and visual), split screen capabilities, and dark/bright adjusting for day and nighttime driving conditions.

Cameras 16D may include a blind spot sensor, dark/Bright adjusting, and 170-degree field of vision, with cloud connection and storage.

Manufactured by components design and the system is a multi-component design product that installs, and the components synchronize with and connects from the command pad and is operational.

Programmed instructions for the operative association of the systemic components with the command pad 18 can be installed, instantiated, and executed using computing architecture.

The self-contained vehicle situational awareness system 10 can simply be mounted to any personal transportation system and communicably coupled to I/O devices of the personal transportation system or a user's mobile phone.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A situational awareness system for a vehicle, said situational awareness system comprising:
a rearward-facing camera disposed on a vehicle equipped with the situational awareness system, the rearward-facing camera having a rearward field of view capturing image data;
an image processor operatively associated with the rearward-facing camera, wherein the image processor is operable to process image data captured by the rearward-facing camera to at least detect objects present in the rearward field of view of the rearward-facing camera;
a command pad having a display, the display operable to display images for viewing by a driver of the equipped vehicle; and
the display is operable to display video images representative of video images captured by said rearward-facing camera in a parameterized field of view representation for viewing by the driver of the equipped vehicle, wherein the parameterized field of view representation comprises a safe zone, an alert zone, a hazard zone, and a collision zone, and wherein each zone is associated with a radial distance from the rearward-facing camera.

2. The situational awareness system of claim 1, wherein each zone of the parameterized field of view is represented in a contrasting color.

3. The situational awareness system of claim 1, wherein the radial distances for the safe zone, the alert zone, the hazard zone, and the collision zone are between zero to fifteen feet, between fifteen and twenty-five feet, between twenty-five and thirty feet, and between thirty and sixty feet, respectively.

4. The situational awareness system of claim 3, further comprising a left blinker and a right blinker, both blinkers physically connected to a housing of the rearward-facing camera and electrically connected to the command pad.

5. The situational awareness system of claim 4, wherein the display is operable to display images representative of an activation state of the left blinker and the right blinker.

6. The situational awareness system of claim 5, further comprising an accessory attachment having a stem portion that extends between a coupler portion and a branch portion, wherein the branch portion is joined to a crossmember, wherein at each end of the crossmember is the left and right blinkers, respectively.

7. The situational awareness system of claim 6, wherein the coupler portion removably connects directly to a housing of the rearward-facing camera.
